(19) United States
(12) Patent Application Publication
(10) Pub. No.: US 2007/0282623 A1
(43) Pub. Date: Dec. 6, 2007

(54) PROCESS FOR PROTECTING CHILDREN FROM ONLINE PREDATORS

(76) Inventor: Jon Dattorro, Palo Alto, CA (US)

Correspondence Address: Jon Dattorro, 345 Stanford Shopping Ctr, Suite 410, Palo Alto, CA, 94304-1413, US

(21) Appl. No.: 11/736,484

(22) Filed: Apr. 17, 2007

Related U.S. Application Data
(60) Provisional application No. 60/794,776, filed on Apr. 24, 2006.
(60) Provisional application No. 60/797,632, filed on May 4, 2006.

(51) Int. Cl. G06F 17/00

(52) U.S. Cl. 705/1

(57) ABSTRACT

A process for protecting children online from sexual predators, contemplated suicide, and premeditated school violence is disclosed: Human female nannys remotely watch computer screens of subscribed children. Using a small cadre of nannys, it is explained why watching large numbers of children is feasible. First, redundancy is introduced to minimize likelihood of a false positive and to ensure no dangerous activity be missed. Next, several forms of time compression are incorporated into the review of children's activities. Further, allocation of nannys to children is expressed mathematically as a covex optimization problem. Review-time of children's activities is thereby minimized with, provably, no better allocation.

### CROSS-REFERENCE TO RELATED APPLICATIONS

This application claims the benefit of provisional patent applications Ser. No. 60/794,776, filed 2006 Apr. 24 and Ser. No. 60/797,632, filed 2006 May 4, by the present inventor.

### FEDERALLY SPONSORED RESEARCH

Not Applicable

### SEQUENCE LISTING OR PROGRAM

Not Applicable

### BACKGROUND OF THE INVENTION

### Field of Invention

This invention relates to the field of computers and the Internet, and more specifically to a process for protecting children from online sexual predators by employing human female nannys to remotely watch subscribed children's computer screens.

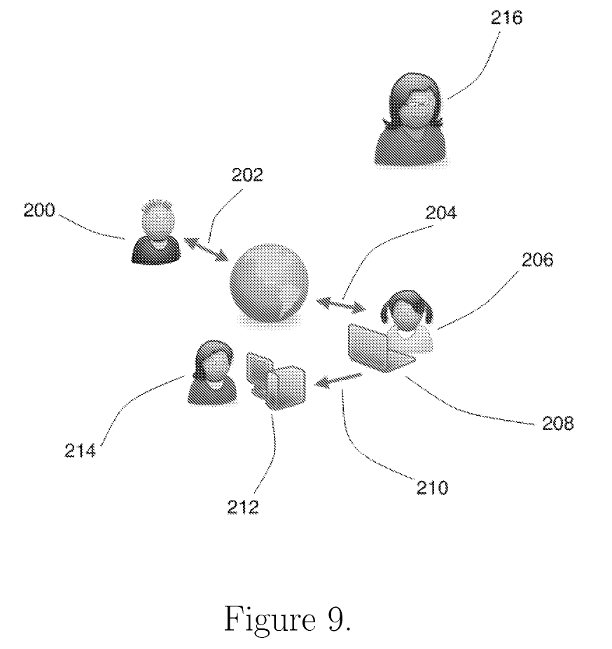

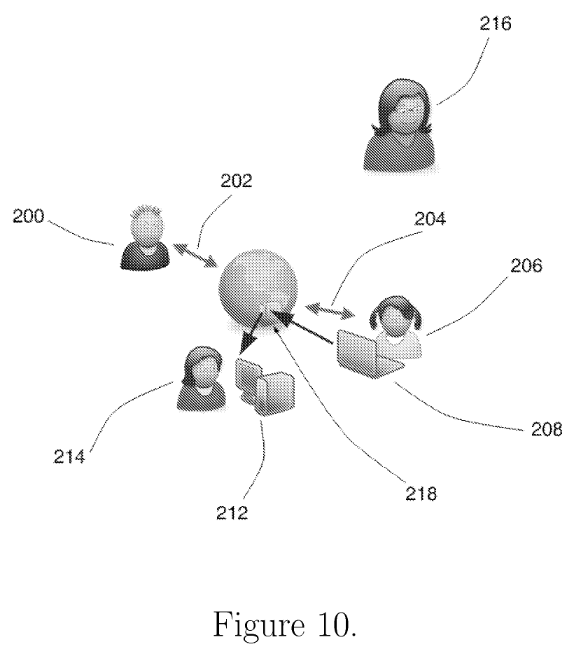

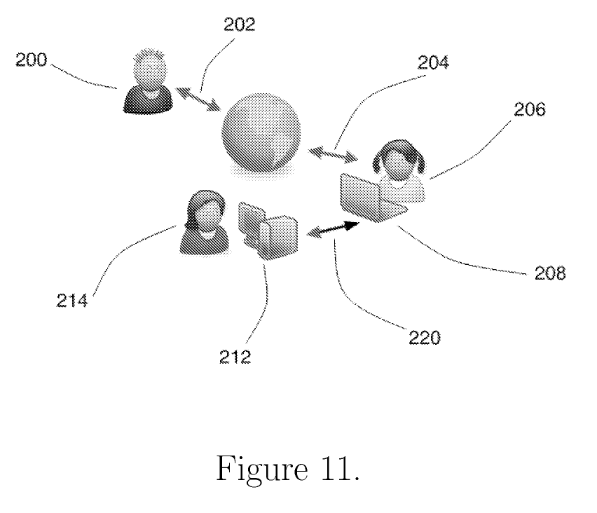

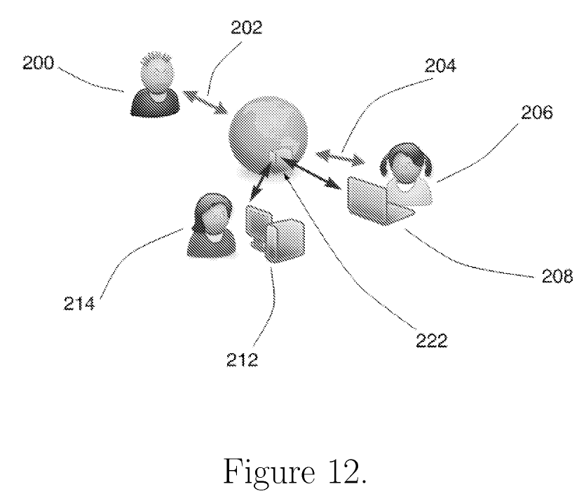

Contents

| 1 | BACKGROUND OF THE INVENTION-PRIOR ART | | 3 |
|---|---|---|---|
| | 1.1 | contemporary prophylatics | 6 |
| 2 | BACKGROUND-OBJECTS/ADVANTAGES/RAM- | | 9 |
| | IFICATIONS | | |
| | 2.1 | advantages of a remote-desktop approach | 11 |
| | 2.2 | simple nanny-allocation system | 34 |
| | 2.3 | multiqueue nanny-allocation system | 37 |
| | 2.4 | nanny-allocation algorithms | 38 |
| | 2.5 | embodiments suiting other applications | 45 |
| | bibliography | | 47 |
| 3 | SUMMARY | | 49 |
| 4 | DRAWINGS-BRIEF DESCRIPTION | | 49 |
| | 4.1 | supporting OJECTS/ADVANTAGES/RAMIFICATIONS | 49 |
| | 4.2 | supporting CLAIMS | 50 |
| 5 | DETAILED DESCRIPTION | | 51 |
| | 5.1 | PREFERRED EMBODIMENT-FIGURE 9 | 51 |
| | 5.2 | ADDITIONAL EMOBODIMENT-FIGURE 10 | 55 |
| | 5.3 | ALTERNATIVE EMBODIMENT 1-FIGURE 11 | 56 |
| | 5.4 | ALTERNATIVE EMBODIMENT 2-FIGURE 12 | 57 |

| | | |
|---|---|---|
| 6 | CONCLUSION | 58 |
| 7 | CLAIMS | 61 |
| 8 | ABSTRACT | 66 |

| | |
|---|---|
| DRAWINGS-ART | 73 |

### 1 BACKGROUND OF THE INVENTION

### Prior Art

If you could actually look through cyberglasses and see who's peering in your window, who's in your daughter's room, who's reading your daughter's blog, who's cyberstalking your son, it is reality. And the fact is that we have become very ignorant to those types of thing because we can't see it.
   Teri Schroeder, iSafe.org. 2006

Sexual predation online began in earnest sometime after the Internet revolution commenced in 1995. Predation has seen abnormally high rate of growth in recent years primarily because of anonymity afforded by the Internet, because there are an estimated 10 times more children online now than in 1995, and because software for hunting children online is easy to use, legal, and freely available.¹
¹MySpace.com is a social networking site facilitating a hunt for “new friends” in a user-specified age group and within a specified radius of any town in the US.

The greatest threat to our nation's children comes not from recidivism by convicted predators.² The greatest threat instead comes from unknown sexual predators; i.e., new predators having no prior criminal record. The Internet has turned otherwise average-looking citizens into predators by virtue of anonymity, and by the fact that an estimated 30 million children are now online. ³
²It can be argued that recidivism is low among those convicted predators having actually served jail time: livescience.com/othernews/060516_predator_panic.html

³http://whitehouse.gov/news/releases/2002/10/20021023.html

Media focus on this topic is white-hot.⁴ Dateline NBC⁵ and law enforcement teach that there is, seemingly, a limitless supply of new online predators that span every age group, social stratum, and socioeconomic class,⁶ but are almost exclusively male. 1 in 5 children are sexually victimized [1, p. 4], according to the National Center for Missing & Exploited Children in Alexandria, Va. Convicted pedophiles include medical doctors, fire-fighters, rabbis, retirees, college students, school teachers, attorneys, law enforcement (from FEMA, and an assistant district attorney from Texas, for example), etcetera; literally, all professions, IQ, and walk of life.
⁴Excellent video reports are available online from distinct perspectives: from points of view of predator and law enforcement: http://msnbc.msn.com/id/11152602 http://msnbc.msn.com/id/12503802 These reports teach that predation is rampant and growing at an alarming rate. from point of view of teens and their parents: http://msnbc.msn.com/id/12242009 Teens themselves report that they take precautions and deny giving personal information to strangers, but this video teaches otherwise. Parents generally have no idea what their children do online. from point of view of parent: http://watchmykidspc.com/press.html International abduction.

⁵Dateline wields national television exposure in a penultimate step to a predator's final moments; exhorting infamy and public humiliation long after his debt to society has been paid. One consequent suicide has been widely reported; assistant district attorney Louis Conradt from Texas: http://msnbc.msn.com/id/15592444

⁶Anyone can enter one of the many free anonymous chatrooms, pretend to be a thirteen year-old girl, and then be solicited for sex within minutes of arrival. This effective demonstration is repeated throughout the country by law enforcement officers (e.g., www.internetchildsafety.net) simply to educate parents.

Law enforcement is admittedly so overwhelmed and ill-equipped to handle this pandemic that, counter to their own long-standing tradition barring collaboration with civilians, sheriffs across the country have deputized the vigilantes known as Perverted-Justice.com to assist with enforcement of solicitation-of-minor laws.

At greatest risk are children who use the Internet for social networking: chatrooms, email, voice over Internet protocol (VOIP, computer as telephone), and instant messaging; i.e., children who use the computer as a communication device.

Children themselves are the greatest liability to their own safety. A child, in fact, gives away more personal information to a stranger online than could ever be acquired by a professional private investigator.⁷ [4, p. 10]
⁷grace.speakeasy.net/˜dattorro/images/WatchMyKidsPC/Myspace.wmv

Most parents think they know what their kids do online.

Parents are clueless. They're caught like deer in the headlights.

Parry Aftab, WiredSafety.org

The single most dangerous behavior, by a child, is physically meeting a stranger who was first met online. Statistics say: chances that an adolescent will physically meet an online stranger can be as high as 1 in 4[2] and almost never falls below 1 in 8 for teens over 13 years of age.⁸ [4, p. [1] That is the most relevant statistic because a parent need only ask: Do I want to take a 1 in 4 chance that my kid will leave the house to meet a stranger without my knowledge. The actual rate of molestation is, therefore, irrelevant although iSafe.org reports kids are being abducted and killed by online sexual predators. Online abduction has spanned oceans, and so can be considered a new form of terrorism.⁹
⁸www.redsafety.org/askparry/special_reports/spr1/qa19.html.

⁹Consider this news story about “a 16-year-old honor student from Michigan who tricked her parents into getting her a passport and then flew off to the Mideast to be with a West Bank man she met on MySpace.com”: ‘MySpace’ teen persuaded to leave Jordan by David N. Goodman, Associated Press, Fri Jun. 9, 2006, 6:54 PM ET. Professor Ilene R. Berson from the University of South Florida teaches that this occurrence is not isolated. [3, §5]

1.1 Contemporary Prophylactics

This phenomenal problem, sexual predation online, arises because of two complementary deficiencies:
social naiveté of the child,
computer illiteracy of parents.
   1.1.1 Education

Traditional methods for protecting children fail regularly. The most prevalent mode of thought, by leading experts, is to educate both parent and child about dangers of the Internet. The flaw in that logic is the presumption that a child is guided more by intellect than by their emotional needs. This educational approach presumes a child capable of making rational decisions while simultaneously ignoring their physical impulses and urges.¹⁰ While education is a necessary step in protecting a child, it is not sufficient.
¹⁰But it is a well-known neurological fact that a child's brain development is incomplete until they reach their early twenties; those parts of the brain affecting judgement develop last. Until then, it is the emotional center of the brain that dominates a child's decision-making.

1.1.2 Legalized Entrapment

To date, there is no completely effective prophylactic measure for protecting children from sexual predators online; technological or otherwise. The most popular snare advocated is legalized entrapment where law officers pose as children in chatrooms; luring predators. By one officer's own estimate, chances of a particular predator getting caught for solicitation of a minor in a chatroom are “fairly slim”.¹¹ Even so, this entrapment technique is becoming widespread simply because of predator abundance in cyberspace.¹²
¹¹grace.speclkeasy.net/˜dattorro/images/WatchMyKidsPC/Predator.wmv

¹²It is dangerous for parents to become even more complacent than they are now; presuming the online predator problem to be solved by police. I think parents have known that this has been around, it's just, their attitude is: “It doesn't happen in my house, it's not going to happen to my son or daughter” says Teri Schroeder of iSafe.org

1.1.3 Surveillance

Surveillance spyware for parents (software purchased by parents for the express purpose of spying on their children¹³) is readily available on the worldwide web for immediate installation on their child's computer. This spyware can record such things as keystrokes, screen shots, unencrypted chat logs and email, and history of websites viewed. That data is then retrievable locally or remotely for scrutiny by a parent. Spyware can also be configured to selectively block “offensive” content from a child.¹⁴
¹³Any software that can be used for covert spying on children can be used for spying on anyone else. Prominent examples of surveillance spyware are NetNanny and America Online (AOL). [5] [6] [9] [10] [12]

¹⁴The spyware-software manufacturer attempts to categorize the billions of existing websites in advance; these black and white lists are then integrated into their software.

1.1.3.1 Obstacles to Surveillance

If chat logs or email are encrypted for transmission, then contemporary surveillance spyware is unable to provide a complete transcript to a parent. This deficiency becomes manifest in each spyware provider's own advertisement of precisely which commercial chatrooms can actually be monitored.

Notwithstanding, foremost deficiencies of surveillance spyware remain:
Use of spyware implicitly presupposes parents know how to:
   operate a computer
   install software
   use the spyware they installed
   hide its existence (if desired) from children.
This assumption is flawed in so far as the child's knowledge of computers is typically superior to that of the parents;¹⁵ some parents know nothing at all about computers and little of the Internet.
   ¹⁵It is far more common for the modern-day parent to ask a child for help with the computer than vice versa because the child's curriculum typically includes computer training.
Spyware is categorized by the computer industry as such (a negative connotation [8]) and the eminent antivirus and antispyware programs (Symantec corp., McAfee corp., Iolo corp.) will remove or disable spyware automatically. Otherwise, a child is alerted to existence of spyware by freely available antispyware (Spybot.com, Grisoft.com) and encouraged to remove, destroy, or disable it.
Spyware requires a parent to be diligent and do work by examining records and reports of their child's activities. It further requires that parents understand what the spyware tells them about their child's activities.

The foremost obstacle to use of surveillance spyware is the child's own superior computer-ability over that of the parents. The computer-savvy child is able to detect existence of surveillance spyware; ways for the child to defeat or uninstall it can be found via Google. A clever child knows how to fool the parents.¹⁶ Websites blocked from a child's view can be visited via proxy server whose existence on the worldwide web serves that exact purpose; an intermediary.¹⁷
¹⁶The Justin Berry case recently featured on Oprah is a prominent example of surveillance spyware failure: Justin's mother is a social worker who specializes in molested children. The mother installed surveillance spyware on her son's computer. The 13 year-old son, Justin, was able to defeat the surveillance and run a child pornography site selling himself right under the mother's nose.

¹⁷It is possible for a particular proxy server to be neither blacklisted or whitelisted; i.e., unknown to surveillance spyware.

### 2 BACKGROUND OF THE INVENTION

### Objects/Advantages/Ramifications

Parents must know not only who their children are talking to online, they must also know what their children are saying.
   Bill Gates, Microsoft corp., 2006

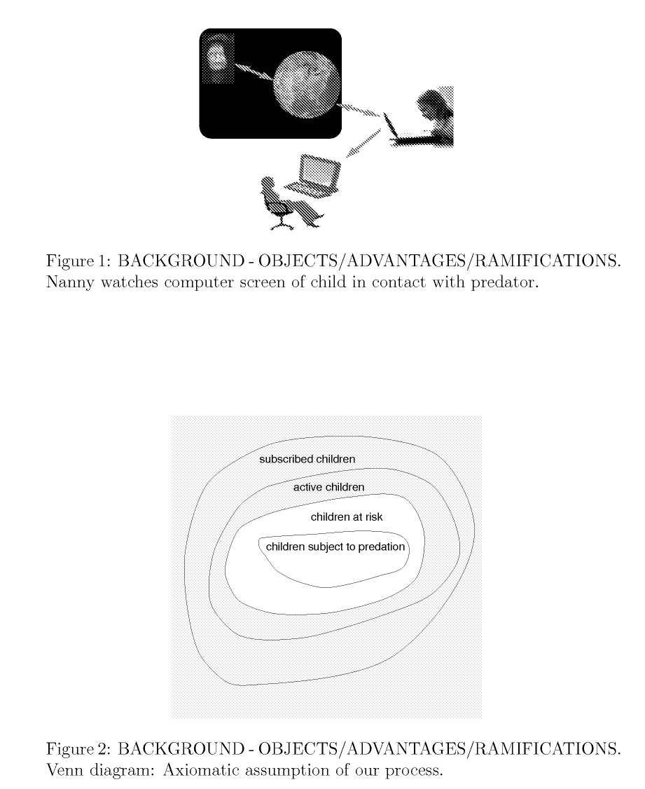

The present disclosure describes how a human female nanny can remotely watch for at-risk behavior in the computer activities of many children; a process for screening children for online predation. The nanny sees and hears exactly what the child sees and hears on their computer, but does not see the child; this is a human service as in FIG. 1.

The primary object of the present invention is to enable a human female nanny with computer assistance to remotely watch one or many children's computer activities with optimal efficiency. This foundation constitutes the claims.

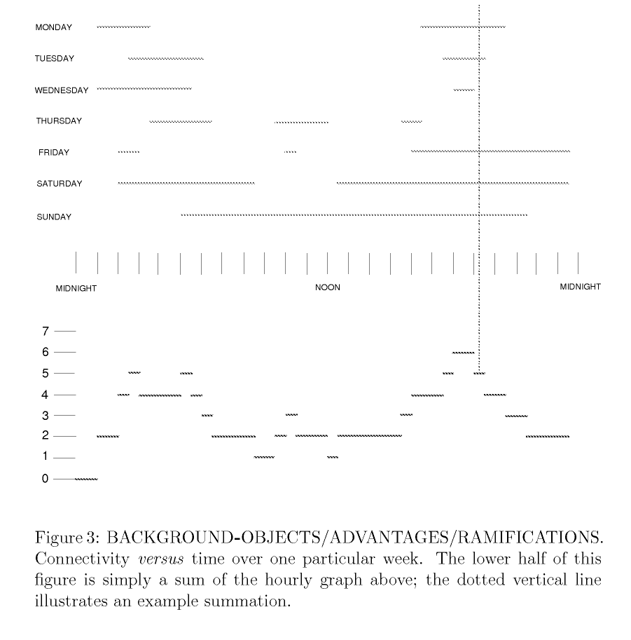

Assume throughout that one nanny means three 8-hour shifts (one nanny per shift). Then our human service is a 24-hour watch with 1000:1 subscribed child-to-nanny ratio. This ratio is achieved because not all subscribed children are active, not all active children are at risk, and not all at-risk children are predated. (FIG. 2) The nanny's computer has a graphical user interface (GUI) that is visually pleasant; ergonomically designed to minimize fatigue and stimulate a nanny's recall of revisited children.

Surveillance spyware prior art is antithetical to the present invention because it defeats the purpose of hiring a nanny; i.e., by design of our process and computer software: the female nanny is not spying on a child, she does the work for parents, and she does a better job than the parents ever could. Surveillance spyware instead places that burden on the parents who were looking for outside help in the first place. So surveillance spyware costs parents time they may not have, and requires skills they may lack. Further, surveillance spyware is incapable of decoding encrypted transmissions sent to or from the child's computer; an obstacle overcome by this invention.

What has prevented others from realizing the present invention sooner was its economic feasibility, threat of liability lawsuits arising from allegations of negligence by a nanny responsible for many children's safety, and reluctance to adopt a human-service business model. Companies already in the business of making surveillance spyware would need to change their business model from a maker of software to a provider of human service; a change they are not inclined to make. We minimize possibility of negligence by building much redundancy into our process so that many nannys care for any given child. What makes this invention economically feasible are ramifications providing multiple simultaneous methods for compressing nanny's review-time of a child's record of activities; e.g., to completely review an 8-hour record of one child in only a few minutes.

Advantages and ramifications in the context of an actual implementation are now discussed:

2.1 Advantages of a Remote-Desktop Approach

Remote-desktop software allows a person to connect to their remote computer, located at home or office, from anywhere in the world where an Internet connection is available. The foremost contemporary representative of this software is called GotomyPC made by Citrix corporation, that is nowhere categorized as spyware. This remote-desktop software allows the person to see and control their remote home/office computer nearly identically to the way it would be seen and controlled were that computer physically present; i.e., were the person sitting right in front of their home/office computer.

So we install remote-desktop software on a child's computer that allows a nanny to watch the child's computer screen from a remote location; the nanny sees and hears exactly what the child sees and hears. So that our service does not become categorized as spyware, a nanny icon is visibly displayed in the notification area of a child's computer-desktop, a right-click on that icon leads to information about the nanny service, and the child is notified by a Windows-style captioned balloon at startup that their computer is being watched. If desired, a parent may also invoke periodic (low frequency) reminders in the form of momentary balloons appearing on the child's screen.

From us, a parent is not buying software. Rather, they are purchasing a human service, only part of which involves licensed installation of remote-desktop software on their child's computer; software that can be immediately downloaded to their child's computer via the worldwide web.

Once our remote-desktop software is installed on a child's computer, experience tells us it becomes apparent to an intelligent and educated human observer (to a nanny watching chat, email, and webcam transmissions) when a child is being stalked by a sexual predator or planning to meet a stranger. The process we developed (and disclose herein) for protecting children from dangers of the Internet by remotely watching their computer activities should, therefore, be offered commercially as a human service (depicted in FIG. 1).

2.1.1 No Wolves Allowed

Sexual predators are nearly all male. Experts
1. author and convicted sexual predator Jake Goldenflame
2. Del Harvey of Perverted-Justice.com
3. Teri Schroeder of iSafe.org
4. attorney Parry Aftab of WiredSafeety.org
5. director Michelle Collins from
   National Center for Missing & Exploited Children
      agree there are almost no female predators of children because human females, generally, know their prey beforehand. Unlike men who will hunt and explore the unknown, women instead lure their victims.¹⁸ Females are almost never found trolling chatrooms where children are preyed by men.
      ¹⁸Hunting magazines popular in the middle of the country assert that only about 25% of registered hunters are female.

One innovation we therefore implement to satisfy parents is to employ only female nannys because of evidence that implies a nearly exclusive genetic predisposition of men to be online predators. We cannot risk a latent predator, because the biggest threat to children are new online predators; i.e., Internet predators having no criminal past. Those male predators generally do not have a criminal record because this phenomenon of online predation is relatively recent. So by latent we mean new and unknown predators.

To further satisfy parents, nannys are automatically prohibited from controlling a child's computer. Nannys are allowed only to observe a child's computer.¹⁹ A child's computer is observable only from a specific Internet protocol (IP) address. This means, for example, a nanny working in a corporate office is not able to watch a child from her home unless the software is configured specifically for her home IP address. In other words, the nanny needs to be using a computer at work to see a subscribed child's computer.
¹⁹Nannys on the West Coast are allocated to watch children on the East Coast, and vice versa. Then in the statistically unlikely circumstance that a female nanny were a predator, there would be no proximity advantage. Nannys are placed in a corporate setting; a large open space without cubicle barriers. Nannys are directly supervised by mobile supernannys.

A child, on the other hand, may be mobile; the child may have a laptop or perhaps a wireless handheld computer that connects to the Internet from many different locations. The child's computer is automatically tracked on the Internet; a nanny can connect to the child's computer regardless of its physical location whenever the kid connects to the Internet.

Thereby, the computer screen of a subscribed child having Internet access who is located anywhere in the world can be watched remotely by a nanny.

2.1.2 Tamper Detection

We designed our remote-desktop software to be legitimately disabled or uninstalled only by a parent via password. The parent may use the same computer as their child, for example, and wish to do some online banking in private. The parent has the option of disabling our service for 15 minutes, 1 hour, 5 hours, or until system restart, etcetera. After the time-period specified by the parent has elapsed, our service is automatically restored. The parent may further create a custom schedule that specifies when their child's computer is and is not to be watched by a nanny.

To discourage a child from disabling or uninstalling our remote-desktop software:
a parental password scheme is employed, and
a nanny notifies a parent by telephone if:
   the child's computer is inaccessible to the nanny for an extended period, or
   the child's computer is not accessible to the nanny when it is expected to be, or
   the child's patterns of activity or connectivity go to zero or depart markedly from past characterizations.
      That way, a parent is notified if their child has defeated our remote-desktop software by any method.

Just how a nanny discovers tampering is now disclosed:

2.1.2.1 Connectivity Detection

A typical teenage girl can spend more than 12 hours per week on a computer. [4] When the computer is not in use, statistically speaking, approximately half the teens will turn it off while half will leave it on. When a computer remains powered on, whether it remains connected to the Internet depends on very many factors. At this moment, we are interested only in characterizing a subscribed child's connection to the Internet. By so doing, deviations from past patterns of connectivity become manifest.

We disclose a graphical characterization of connectivity that we developed: First define
CONNECTED: Computer is connected to the Internet.
ONLINE: Avail of any communication channel.
DISCONNECTED: Not Connected.
WINDOW: Visible pane of a user interface that can be open, closed, resized, moved, overlaid, etc.
DESKTOP: That area background to and comprising all windows in the desktop metaphor of computer user-interfaces; i.e., the visible computer-generated screen image.
REMOTE-DESKTOP SOFTWARE: Software that provides view and control of a remote device's desktop; a remote user is made aware of its presence.

FIG. 3 shows the hours during each day of one particular week when a particular subscribed child's computer was found connected to the Internet.²⁰ The lower half of the figure is simply a sum of the hourly graph above. Each line-segment in the top graph is counted as 1 unit in the lower graph. The vertical dotted line crossing upper and lower graphs illustrates how the lower graph was calculated at a particular instant; every line-segment crossed by the dotted line in the upper graph is counted as 1 and then that subtotal is plotted in the lower graph.
²⁰Connectivity can be detected by the remote-desktop software's ability to respond to a query (a ping) from a company Server.

The example in FIG. 3 shows connectivity over one week's duration, for purpose of discussion. But duration is a parameter that can be arbitrarily set, within bounds, by a nanny. A particular kid's connectivity is examined periodically. Zero connectivity or large deviations from past activity can be an indicator of tampering.

2.1.2.2 Activity Detection

A few simple terms, assuming kid is connected:
AFK: Away From Keyboard
   (no key presses, no mouse movement/clicks, no audio/video transmissions over some time period).
ACTIVE: Applications open and not AFK.
INACTIVE: No Applications open or AFK.
IDLE: An Application is deemed Idle when there is no increase in corresponding CPU time over some duration. If AFK, no determination is made.

APPLICATION: Any computer program having a nontrivial user interface.

AFK?

| | | no | yes |
|---|---|---|---|
| Applications open? | no | Inactive | Inactive |
| | yes | Active | Inactive |

We therefore define existence of Activity on a child's computer as a child who is not AFK and who has Applications open. How to discriminate dangerous activities is discussed in §2.1.6.

A plot illustrating existence of Activity on a weekly basis is made in the same manner as the plot of Connectivity we already discussed in FIG. 3. A child who is characteristically Active on a weekly basis will be suspect to tampering if their Activity drops to zero or if their plotted patterns of Activity change dramatically from past patterns.

2.1.3 Digital Signal Processing in a Remote-Desktop Algorithm

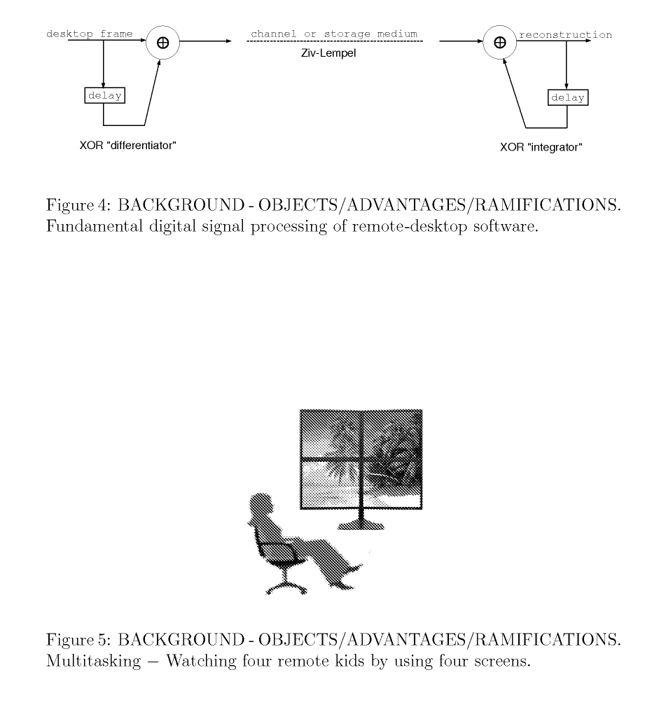

A handful of competing companies now offer remote-desktop software commercially.²¹ FIG. 4 depicts a perfect reconstruction system that we use in our remote-desktop software for transmission of losslessly compressed digital frame data.
²¹Prominent representatives of remote-desktop software: Microsoft Remote Desktop, Webex penow (applied by Dell for remote customer assistance), Symantec pcAnywhere, eMando.net eMando, Virtual Network Computing (VNC), and Citrix GotomyPC.

FRAME: a snapshot of a computer screen;
   digital rendering of desktop at a particular instant.

In the figure, our channel is the Internet. The frame rate (the rate at which successive frames are transmitted over the Internet to a nanny) is typically 10 frames per second but can be as high as 30 frames per second, depending on channel bandwidth and amount of data compression achieved.

Some transmission techniques for remote-desktop software are in the public domain. A pixel-wise arithmetic difference of successive frames is the data commonly recommended for transmission over the Internet.²² But the Boolean operation XOR on successive frames that we use is more computationally efficient than an arithmetic difference because only one's complement (versus two's complement) arithmetic is required in a computer implementation.
²²www.microsoft.com/windows/windowsmedia/howto/articles/enclfc.aspxi

In FIG. 4, each desktop frame is XORed (pixel-wise) with the previous frame prior to transmission. The XOR operation leads to data compression because any corresponding portions of successive frames that are identical will produce zeroes at the XOR output. The XORed frame data is then encoded for transmission by a Ziv-Lempel lossless encoder,²³ a technique based on detection of exact repetition of pixel patterns in the image domain. Long strings of zero-valued pixels from an XORed frame compress nicely. The reconstruction-side decodes the Ziv-Lempel-encoded data at channel output, and then XORs each decoded frame with the previously reconstructed frame. This recursive algorithm²⁴ provides perfect (lossless) reconstruction efficiently and without use of arithmetic adders (which are more computationally intensive²⁵).
²³a well-known program in the public domain called ZIP.

²⁴One nice feature of this circuit is that the reconstructed image sequence can be reversed by XORing the channel output with only the most current reconstructed output. This feature lends to easy scrolling of frames backward and forward; a. k. a, rocking.

²⁵Other vendors replace the XOR “differentiator” in FIG. 4 with a JPEG compressor to reduce required channel bandwidth, but the resulting reconstruction is lossy and the computation is intensive.

2.1.4 Time Compression

Critical to achieving our 1000:1 subscribed child-to-nanny ratio is the concept time compression. One form of time compression, easily understood, is achieved simply by playing back prerecorded material at a rate higher than that used to make the record.²⁶ There are many forms of time compression, and we are obligated to apply almost all of them:
²⁶All the old television shows, for example, are played back a few percent faster to fit into contemporary broadcast time-slots (20 minutes content, 10 minutes advertisement). Musical pitch of audio in a compressed show must be corrected electronically to avoid the chipmunk effect. http://www.stanford.edu/˜dattorro/Lexicon.htm

2.1.4.1 Event-Based Remote-Desktop

A remote-desktop approach to watching subscribed children, while logical, is time intensive. During much of the time spent viewing a remote desktop, the screen is static in the sense that not much changes; the pace is typically quite slow even if an online chat is ongoing. More simply put, if a nanny were watching activities unfold in real time, then there is no time-compression of the record; i.e., activities and their review would be in 1 to 1 correspondence.

On the other hand, transcript of a chat spanning several hours can be read and comprehended completely in only a few minutes. Compressing 6 hours of kid activity down to 6 minutes of nanny review-time would be an example of time compression; in this example, a 60 to 1 compression ratio that is empirically realistic.

A commercial remote-desktop application captures too much information; as many as 30 frames per second or, more typically, 10 frames per second. It makes sense, therefore, to instead sample the remote screen at intervals such that important events are preserved while ignoring unchanging screens.

This reasoning leads to the idea of event-driven remote screen capture: We define an important remote event:
EVENT: mouse left-click or Enter-key hit (carriage return).
   Since the screen is most likely to change with such an event, it makes sense to capture the remote screen at event occurrence; whose rate is, on average, less than 1 event per second.²⁷ Event-detection alone, therefore, provides significant time compression of remote-screen review because events typically occur at low rate (on the order of 1 frame per second).
   ²⁷Double clicks are easily handled because the operating system of each child's computer tells us the maximum time-interval for two successive clicks to be interpreted as a double click. There is, therefore, no danger of doubling screen-information captured.

In all discussion that follows, screen-information captured by our remote-desktop software is assumed to be event-driven unless real-time observation (10 to 30 frames per second) is explicitly called for.

2.1.5 Time Compression by Parallel Embodiment

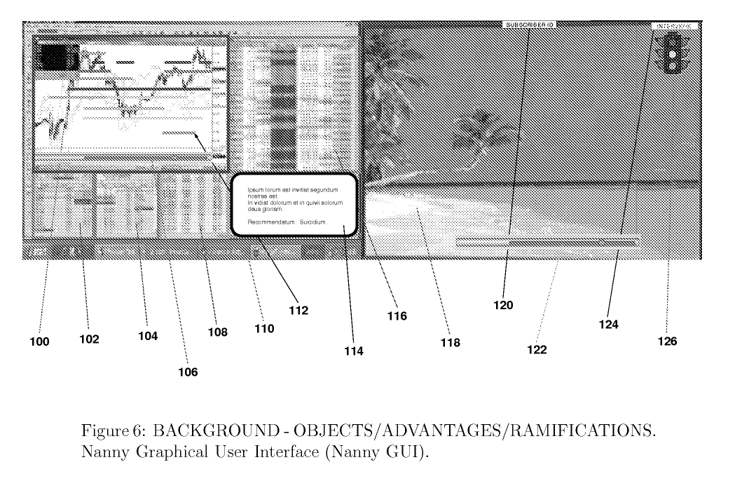

Another form of time compression is multitasking; a nanny watching many kids at the same time. (FIG. 5)

One undocumented feature of GotomyPC is the ability to simultaneously connect with many remote personal computers (PCs) at once. While researching prior art, we discovered that the total Internet bandwidth required to watch multiple remote PCs simultaneously is significantly less than that predicted by summing the bandwidths required to watch each PC alone; in more mathematical terms, our empirical observations reveal that total required bandwidth is not linearly additive. Total Internet bandwidth required is instead closer to the square root of a sum of squares.²⁸
²⁸The reasons this is true may have more to do with the implementation of GotomyPC than it has to do with anything intrinsic to technology of the Internet and networking.

This means that the number of remote kids' PCs simultaneously observable by one nanny is significantly greater than the number implied by the Internet bandwidth required to observe a single PC alone.²⁹′ This phenomenon suggests a novel application for software like the remote-desktop we developed: the ability to watch one or many children's computer activities simultaneously.
²⁹The resources required to watch multiple kids (using only 1 computer and perhaps 4 screens as in FIG. 5) are well met by today's consumer-computer technology. A fiber optic Internet cable (of very high bandwidth) routed directly into a home/business optical modem became available to consumers from Verizon on the East coast some time before July 2006.

2.1.6 Time Compression by Dangerous-Activity Detection

Remote-desktop software that we developed detects dangerous activities like participation in chatrooms; virtual places on the Internet where children are often solicited by predators. Thus a nanny, whose attention may be momentarily diverted to a particular child, is automatically alerted to suspicious, dangerous, or high-risk activity by another child.³⁰
³⁰How a nanny responds to this potential overload condition is disclosed in §2.4.1 as a sequential embodiment more appropriate for large numbers of children; i.e., how to protect children on a large scale by optimal nanny allocation. [7]

That is yet another form of time compression because automatic detection of dangerous activity makes the nanny's job more efficient.

Dangerous-activity detection by our remote-desktop software is accomplished quickly and automatically by reading the task list ³¹ a manifest of currently running programs provided by the kid's computer's operating system. Risk level (§2.1.7.7), ascribed to each kid by our remote-desktop software, is an objective measure of dangerous activity; it is a ranking that assesses:
³¹The task list is located in the Task Manager on Microsoft Windows operating systems.

1. how many dangerous Applications the kid has open
2. instances of dangerous language in transcripts
   (sex talk, “let's meet” talk)
3. number of dangerous websites opened.
   Risk level is maximized if our remote-desktop software further detects a known predator in the various chat logs or email, whereas it is minimized for a connected kid who has no Applications running.

We mine historical data that we collect about dangerous language and predators, then use it to automatically alert a nanny when any subscribed child may be in danger; solicitation by a repeat-offender, perhaps. Suppose, for example, SpecialGuy29 is known to us for soliciting minors.³² Then upon detection of this handle, we know that any child engaged in conversation with him is, most likely, being solicited. Effective use of our historical data will, of course, increase nanny efficiency (hence, more time compression).³³
³²SpecialGuy29 is an assumed name, login, or handle, corresponding to a particular, possibly anonymous, individual. Handles are necessarily unique within a particular chatroom or email provider; e.g., Assuming SpecialGuy29 is not in our database, then upon first discovery of a subscribed child communicating with SpecialGuy29 we can mine the Internet looking for biographical information attached to that handle. Since the advent of Google and similar search engine technology, this investigative technique can be quite effective for purpose of identification.

³³When a nanny detects solicitation or stalking by a known sexual predator, the parents are notified by telephone and further advised. A transcript of the proceedings, leading to that nanny's Intervention, is then provided to the parents.

A webcam (an inexpensive video camera), integrated with a child's computer, is now common. A solicitation technique, often employed by predators, is to transmit erotic photos to the child who is then encouraged to perform the depicted behavior for their webcam. Existence of any webcam transmissions to or from the child's computer would therefore be categorized as dangerous activity.

2.1.7 Time Compression Under a Sequential Embodiment

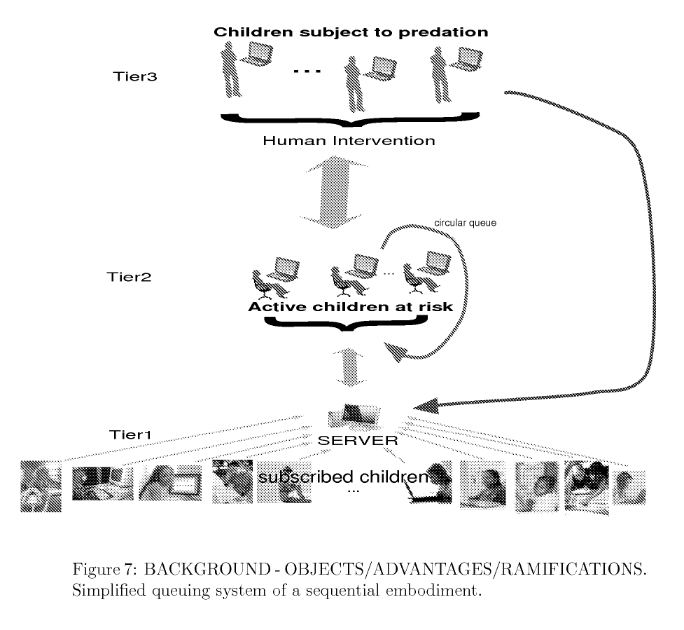

In its simplest form, the idea for watching many remote kids simultaneously comprises a multitasking nanny (as in FIG. 5) who is provided with tools and methods for prioritizing kids by their Risk level. While that is a viable process for watching kids, we can instead design Server³⁴ software to provide a nanny with a sequential presentation of prioritized individual kids; a method more amenable to large numbers of children, and the method preferred in practice.
³⁴A server is a specialized computer located in a data center. The most common role of a server is as host to one or many websites. Our Server acts as an interface between the Subscriber base and nannys as in FIG. 7. A data center is a public node, of extremely high bandwidth on the Internet, housing many servers owned by corporations, businesses, and individuals.

To completely review an 8-hour record of one child in only a few minutes, we must devise an efficient nanny user-interface. First some pertinent terms:

2.1.7.1 Glossary

(Refer to FIG. 6)

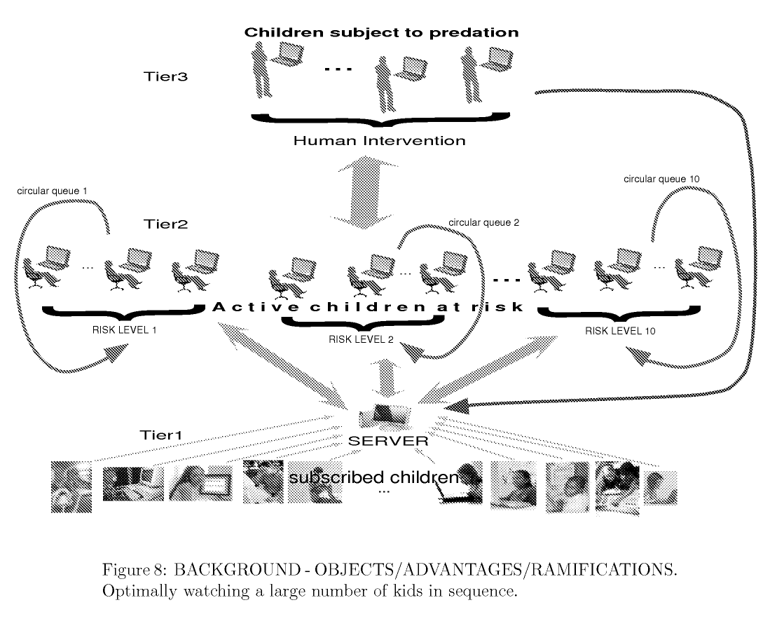

AVAILABLE: A nanny becomes Available whenever she is not evaluating a kid; i.e., after she clicks on stoplight 126.
   (Refer to FIG. 8)
QUEUE: as in computer science; a queue of kids.
   Circular queues are indexed by Risk level.
TIER: A system of nannys:
   Tier 1 is the Subscriber base.
   Tier 2 (kids at risk) has multiple circular queues discriminated by Risk level (there exists only one queue in a simplified algorithm). Each circular queue has a graduated maximum review time.
   Tier 3 handles kids subject to predation.
INTERVENTION: Notification to guardian of threat to a child.
THREAT LEVEL: Ascribed by nanny; determines which
   tier a kid is on:
   KID BENIGN (OK)—(Green=Tier 1),
   KID AT RISK—doing dangerous things
      like chatting (Yellow=Tier 2),
   PREDATED KID-suspected of being
      attacked by predator (Red=Tier 3).
RISK LEVEL: A nonnegative integer calculated automatically; basically, determines to which circular queue a kid is assigned. Risk is a count of:
   1) dangerous open Applications,
   2) dangerous keywords,
   3) dangerous websites.
   Risk level does not change upon Disconnect or Inactivity. Risk level is 0 for kid with no open Applications. Risk level is maximized when a known predator is detected.
GUI: Graphical User Interface.
WEBPAGE: Resource of information suitable for dissemination via the worldwide web, and accessible via web browser like Microsoft's Internet Explorer.
   2.1.7.2 Nanny GUI

The basic nanny workstation comprises two contemporary 20-inch monitors by side. Refer to FIG. 6:
100 Graph of Risk level over time. (not clickable)
102 Chat item selector. Transcript opens in 116.
104 eMail item selector. Transcript opens in 116.
106 Scrollbar under Risk level graph 100 synchronizes other windows (as in Microsoft Windows) to a selected time in the historical record. That time selected corresponds to scrollbar position. Scrolling is controlled by conventional methods: mouse click & drag or left/right arrow keys.
108 Website selector. Selection opens remote-desktop history in 118 (scrollbar 122 is tracking).
110 Local Windows taskbar holding a browser application, time/date, and any other applications a particular nanny wants.
112 Each track (§2.1.7.8) represents timeline of an open Chat window, eMail reader, web browser, or other dangerous Application. (Tracks are clickable.)
114 Nanny notes; regarding kid under scrutiny. These notes are available to all nannys when viewing this particular kid.
116 Transcript of Chat or eMail item.
118 Event history and real-time remote desktop of kid.
120 Subscriber ID is internal designation for a subscribed kid. It is a movable window without skin.
122 Past-history scroll control for this window 118 only. Scroll full-right yields real-time remote desktop. Scrolling is controlled by click & drag or left/right arrow keys. Scrollbar is a movable window without a skin.
124 When nanny clicks on stoplight 126, the next kid generally appears. When the word INTERVENE appears instead (in a movable window without skin), it means the present kid was awarded a Red Threat level from two consecutive nannys. Intervention is then required.
126 Nanny ascribes Threat level by clicking light on stoplight. Green means a benign kid. Yellow means kid is at risk. Red is a predation alarm. This action generally exits current kid from nanny observation. Stoplight is a movable window without skin.
   2.1.7.3 GUI Design

The main attribute of this interface design in FIG. 6 is efficiency. When a nanny sees a new kid, there is no interface construction by hand (window opening or movement by dragging as in Microsoft Windows) or other form of setup required. The Nanny GUI is fully ready and functional at new-kid startup. This design philosophy eliminates repetitive tasks.

The Nanny GUI we designed is transcript-centric with the option to synchronize transcripts, and to switch between them quickly within a single subwindow 116.

What makes a nanny's job somewhat enjoyable is her own innate curiosity; e.g., she sees each kid's desktop: what they have chosen as their background image, the icons displayed, the games they play, their day-to-day activities, etcetera. These visual queues will trigger her memory of certain children when revisited.

If not for a child's chosen visual environment and ambiance, a nanny's job could become somewhat like reading a telephone book for 8 hours per day. As her employer, we want some enjoyment to occur. Otherwise, the nanny attrition rate is too high and our company might fail.³⁵
³⁵A good analogy would be a candy manufacturer's permission for their employees to eat candy while on the job. That is actually done in practice, by the way.

2.1.7.4 GUI Detail

Risk level graph 100 in FIG. 6 reveals hot spots (appearance and density of dangerous keywords, websites, and risky applications, §2.1.7.7) to a nanny at a glance over the past 8 hours.

Tracks 112 (the collection of horizontal stripes overlaid on the graph of Risk level 100) indicate opening and closing of corresponding windows, over time, and their respective color-coded Risk.

Scrollbar 106 synchronizes other windows in the Nanny GUI to that time corresponding to its horizontal position.

Chat and eMail item selectors, 102 and 104 respectively, are chronologically ordered lists. Clicking an item causes appearance of the corresponding transcript in 116. Keywords in Transcript subwindow 116 are highlighted and color-coded for Risk level. Each list item in selectors 102 and 104 is also color-coded to indicate Risk level so a nanny can preferentially visit hot spots. Each list can be scrolled by a standard Windows scrollbar.

A nanny may synchronize other windows or transcripts to a particular list-item in 102 or 104 via menu provided by right-click. Suppose, for example, the nanny chooses to synchronize other windows to a particular Chat transcript in 102. Then the corresponding Chat window appears in monitor 118, from the recorded history of the kid's desktop, exactly as the kid saw it.

In this manner, any potential barriers associated with retrieval of encrypted³⁶ chat or email transmissions are circumvented.
³⁶Encryption of chat (for privacy) is coming more into existence at the time of this writing. Most all commercial surveillance spyware vendors are foiled by encryption.

Website selector 108 is a site-centric list with the ability to switch between visited sites quickly. The sites are listed chronologically in 108. Websites appearing in the list are color-coded for Risk. When a site is selected, recorded history of a kid's desktop (commencing with the browser depicting that visited site) appears in monitor 118 exactly as the kid saw it on their computer screen. Scrollbar 122 is synchronized to the selection in 108. Website selector 108 can be scrolled by a standard Windows scrollbar. A nanny may choose to synchronize other windows to a selected item via right-click menu option.

2.1.7.5 Real-Time Remote Desktop

When righthand monitor 118 is driven by scrollbar 122 below it, then monitor 118 becomes a chronological event-driven record of a kid's desktop. A nanny may synchronize other windows via right-click on 118 or 122. When scrollbar 122 is fully right, then the image appearing on 118 is a real-time remote desktop of the kid being watched.

2.1.7.6 Threat Level

After a nanny has finished evaluating a kid, she exits that kid and simultaneously ascribes a Threat level by hitting stoplight 126 on the righthand monitor 118. Threat level (Green=Tier 1, Yellow=Tier 2, Red=Tier 3), determined by a nanny, assigns a kid to a particular tier. (§2.2, FIG. 7, FIG. 8) If she clicks on the Red light then the kid goes to Tier 3 (unless already on Tier 3, in which case Intervention occurs), if Yellow then the kid goes to Tier 2, if Green then the kid goes back to Tier 1 (the pool of subscribed children).

2.1.7.7 Risk Level

Risk level (graph 100 with respect to time in FIG. 6) is a count (a nonnegative integer); remote-desktop software counts number of dangerous Applications open, number of dangerous keywords in transcripts, number of dangerous websites, etcetera, and then simply adds them. There is, therefore, no artificial ceiling imposed on Risk level.

Our objective here is to refrain from making a qualitative judgment of one Application or website as being worse than another by a certain degree, or one keyword worse than another by a certain fraction. A keyword like “meetup” (and all its misspellings and synonyms) is simply dangerous regardless of context; a Boolean decision.

Fluctuations in Risk over time are caused by a kid opening and closing dangerous Applications, surfing to dangerous sites on the worldwide web, and typing dangerous keywords. Graphical presentation of Risk is not cumulative over all time; otherwise, Risk would tend to be monotonically nondecreasing. Dangerous events are instead accumulated (counted) over some sliding time-interval specified in minutes; this will make Risk's graphical presentation more locally meaningful. The amount of time over which dangerous events are accumulated becomes the graph's resolution. ³⁷
³⁷Equal weighting of each accumulated event, achieved by simply counting their occurrence, provides a digital filtering (popular in statistics, economics, and audio) known as a moving average filter.

Nannys, by their experience, are accustomed to seeing various graphical patterns of Risk. When Risk does not meet her expectations, a nanny is more attentive. Conversely, by experience, she quickly recognizes a relatively benign kid.

When a child's computer goes down or interruption of service occurs over the Internet, our Server automatically attempts reconnect to that child's computer. Risk level does not necessarily change on AFK or disconnect from the Internet.

2.1.7.8 Tracks

Appearance of tracks 112 overlaid on Risk level graph 100, in FIG. 6, correspond to opening- and closing-time of particular windows (as in Microsoft Windows) by a kid over an 8-hour period. Each track corresponds to a particular open window. Multiple windows, open simultaneously, appear as corresponding multiple tracks, whereas similar windows open and closed consecutively may appear along the same track (which can then possibly appear having gaps).

A nanny can therefore ascertain sheer amount of activity at a glance by looking at the distribution of tracks. Each track is color-coded to indicate Risk level. The color may indicate either average or local Risk to within some time resolution. Color coding is a good indicator in so far as relative Risk of each and every activity can be ascertained at a glance.

Tracks are clickable. By clicking on a Chat track, for example, the corresponding Chat window appears highlighted in 102, the Chat item selector, while the corresponding Chat transcript appears in subwindow 116 synchronized to that time at the point of click.

2.1.7.9 Keyword-Database Inclusion

A nanny can submit any keyword for inclusion into a database of dangerous language.³⁸ A keyword candidate is simply highlighted via mouse, then a right click presents a menu to the nanny; one menu item is for keyword submission. The nanny's internal identification, context, and special comments are included in her submission.
³⁸This inclusion is not automatic, but instead subject to human approval. This second evaluation will minimize accidental list-contamination.

2.1.8 Time-Compression Strategy

Our objective is to achieve great time compression when reviewing 8-hour historical records of a child's activity; i.e., we want a nanny to review 8 hours of kid-data in only a few minutes. There are several ways to achieve time compression and we need to implement nearly all of them to obtain the economic feasibility of remotely watching a single child's computer 24 hours per day, 7 days per week:
1. multiple monitors for basic nanny workstation (FIG. 6),
2. efficiency-maximized Nanny GUI (§2.1.7.2),
3. color coding; e.g., in bidirectional chat/email transcripts,
   manifest of websites visited,
4. event-based capture of subscriber screen images (§2.1.4.1);
   i.e., event-driven remote-desktop,
5. automatic dangerous activity (§2.1.6) detection;
   automatic Risk level assessment (§2.1.7.7),
6. time-compression of audio by digital signal processing.³⁹
   ³⁹http://www.stanford.edu/˜dattorro/Lexipatent.htm

Nannys review the past 8-hour record of any subscribed child who was active with nonzero Risk level at any moment in that time period. That 8-hour historical record is a sliding window into the past with respect to that moment a review begins. Nannys review a child regardless of activity level at the moment of examination. For the child's safety, time between visits by a nanny should never exceed a shift-period of 8 hours.

If the period between visits is less than 8 hours, then overlapping portions of a kid's history will be viewed by multiple nannys. This redundancy is good and indicative of a “cruising mode” of system operation. Whereas, if a child were reviewed only once in 8 hours (with an 8 hour record), then the company would be operating at capacity and there would be no redundancy; that is, the company would reach a critical point of operation.

We wish to operate with enough redundancy that probability of missing a critical event is significantly minimized.

2.2 Simple Nanny-Allocation System

The primary distinguishing feature of a more sophisticated queuing technique is an automaton (the Server) for determining which kid needs to be seen next, and to which kids a nanny is allocated. Human female nannys still make nearly all remaining decisions. The main attribute of the system in FIG. 7, for watching many kids in a sequential embodiment, is a single circular queue on Tier 2.

2.2.1 Tiered Embodiment

Children's activities are classified (tiered) according to a graduated Threat level. An active child continues circulating through tiers of watchful nannys unless it is redundantly determined that the child is subject to predation. Tiers are abstractions; meaning, the nannys are not necessarily physically located as depicted in a central office. But the physical network of computers and nannys is indeed as depicted. Tier 1 is the Subscriber base with automated Risk level assessment.

All subscribed children on Tier 1 are screened by the Server for existence of nonzero Risk level in the past 8 hours. All children at risk are placed in the Tier 2 lone circular queue. Children at risk are scrutinized in turn by the next Available nanny; there is no preferential treatment. Risk level is relegated to a gauge used by a nanny to help her quickly locate dangerous behavior.

While a nanny is evaluating one kid, data for the next kid at risk waiting in line can be downloaded in the background to that nanny. Transmission-delay from Server to nanny is thereby minimized.

After a nanny finishes evaluating a kid, she ascribes Threat level by clicking on a light in stoplight icon 126 in FIG. 6. Threat level determines tier assignment of a kid: Red is Tier 3 (Intervention occurs if a second nanny concurs), Green is Tier 1 (Subscriber base), while Yellow indicates a kid at risk who is therefore sent back to the circular queue on Tier 2. Clicking on the stoplight exits that kid in the Nanny GUI unless Intervention is required.

A nanny on any tier can send a kid to any other tier. If a child on the second tier is being solicited for sex, then the child is passed to a third tier where a second nanny independently determines whether that child is subject to predation. If the second nanny disagrees, then she sends that kid to a tier of her choosing. But if that Tier 3 nanny chooses Tier 3, then Intervention occurs as indicated by alert 124; a predated kid is taken out of the nanny allocation system, represented by FIG. 7, and a parent is notified.

Summarizing our tiering scheme:
Tier 1. A Server checks subscribed remote computers on Tier 1 for risky activity in the past 8 hours, and then places at-risk children in a circular queue on Tier 2.
Tier 2. A second-tier nanny watches an at-risk child until she determines whether or not that child is subject to predation;
   if a child is deemed not at risk and inactive, then that child is sent back to the Subscriber tier by the nanny, (Green Tier 1)
   if an active child is not subject to predation, then that child goes back to some tier determined by the nanny (Green Tier 1, Yellow Tier 2) and the process repeats,
   if a child is subject to predation, then that child proceeds to a third tier of female nanny where the child's activity is reviewed again. (Red Tier 3)
Tier 3. If a child is subject to predation (Red) in the opinion of a nanny on the third tier, then that third-tier nanny exits Tier 3 with that child and performs Intervention. Otherwise, the child is sent back to some tier (determined by the nanny) and the process repeats ad infinitum
   2.2.2 Goals of the Invention
   2.2.2.1 Second Opinion

We provide a failsafe mechanism to reduce probability of a false positive: When it is determined that a child is being solicited by a predator, that child is handed off to a higher tier where a second nanny makes an independent determination.

2.2.2.2 Redundancy

We insure that no child be mistakenly ignored: A nanny must ascribe Threat level to a given child before she is allowed to review another child. During perpetual observation of a particular child cycling through the tiers, many nannys evaluate that same child. Probability of missing a threat to a child is, thereby, minimized.

2.3 Multiqueue Nanny-Allocation System

Now we introduce prioritization into the queuing technique for watching many kids in a sequential embodiment. Conceptually, at-risk kids wait in a circular queue for observation by a nanny. But kids with higher risk-level are seen more often, and low-risk kids are seen less so.

This prioritization scheme is implemented by having multiple circular queues on Tier 2, as in FIG. 8, each characterized by a different circulation time; higher-risk kids cycle faster. Average or peak Risk level determines to which circular queue a particular kid is automatically assigned by the Server. Rate of circulation around each queue is controlled by how many nannys are allocated to each; the more nannys allocated to a particular queue, then the faster that kids are seen there.⁴⁰ The automaton increases nanny efficiency by readying the next kid in line for each queue.
⁴⁰Given desired relative rates of circulation, optimal solution to this convex optimization problem (§2.4.2) is efficiently found numerically. [7]

Although decreasing the amount of time between visits to kids at elevated Risk levels, multiple circular queues actually significantly increase total amount of time required for a fixed total-number of nannys NumNannys to see all the kids. Otherwise, there is no fundamental conceptual difference in this particular embodiment of the present invention; the basic idea remains intact: A remote nanny watches a multiplicity of kids.

2.4 Nanny-Allocation Algorithms

FIG. 2 is a Venn diagram of the assumptions critical to economic feasibility of the present invention. If we ascribe nomenclature Subscribed to mean total number of subscribed children, NumKidsₐ the number of active children at any particular moment,⁴¹ NumKidsₐᵣ the number of active children at risk, and NumKidsₐᵣₚ the number of children subject to predation, then it is clear from the Venn diagram that the following inequality must hold:
⁴¹We measure number of children by observing records throughout 8 hours into the past with respect to that given moment in time. Measurements of the other numbers are made similarly.

NumKidsₐᵣₚ≦NumKidsₐᵣ≦NumKidsₐ≦Subscribed (1)
In words, the number of children subject to predation must be less than (or equal to) the number of active children who are at risk at any given moment. The number of children at risk must be less than the number of active children. And the number of active children must be less than the number of subscribed children.

Assuming that children subject to predation NumKidsₐᵣₚ can be segregated from the subscribed children efficiently, then the number of nannys NumNannysₐᵣₚ in Tier 3 need not exceed NumKidsₐᵣₚ.

Suppose the number of nannys allocated to Tier 2 is denoted NumNannysₐᵣ. Because the number of at-risk children NumKidsₐᵣ at any given moment is a dominant factor when determining the required total number of nannys
NumNannysΔNumNannysₐᵣ+NumNannysₐᵣₚ (2)
then we can minimize NumNannys in the long term simply by assessing risk more carefully. (§2.1.7.7)

FIG. 8 shows how children flow through tiers and queues. FIG. 7 is an embodiment simplifying the mathematics of nanny allocation by eliminating all the faster circular queues. That embodiment generally reduces total time required to review all the children when compared with the multiqueue system in FIG. 8. FIG. 7 is therefore an instrumental variation of the sequential embodiment in FIG. 8.

2.4.1 Simple Optimal Nanny Allocation

Now we minimize time to watch a large number of subscribed children as in FIG. 7. Suppose time for the average nanny to review a child on Tier 2 is measured and determined to be Tₐᵣ seconds; likewise, Tₐᵣₚ seconds for an average nanny on Tier 3 to determine whether a child is subject to predation. These average review-times and numbers of children (NumKidsₐᵣ & NumKidsₐᵣₚ) are measured periodically by the Server in real time. Then the time taken to pass all active children at risk through Tier 2 once is (NumKidsₐᵣTₐᵣ)/NumNannysₐᵣ seconds, while it takes (NumKidsₐᵣₚTₐᵣₚ)/NumNannysₐᵣₚ seconds to redundantly check for predation on Tier 3.

Using well-established terminology from computer science, FIG. 7 is representative of what is known as a parallel/pipeline process. The pipeline comprises: Tier 1 . . . Tier 2 . . . Tier 3, while nannys on a particular tier work in parallel. Total review time Tₜₒₜ (the time it takes to determine how many subscribed children are subject to predation) is predominated by the slowest tier; approximately,

$${T}_{tot} = max \{ \frac{{NumKids}_{ar} {T}_{ar}}{{NumNannys}_{ar}} , \frac{{NumKids}_{arp} {T}_{arp}}{{NumNannys}_{arp}} \} \qquad ( 3 )$$

Nanny performance is inversely related to total review time Tₜₒₜ which is minimized by manipulating the only variables under direct control; those are, number of nannys allocated to each tier: NumNannysₐᵣ and NumNanntysₐᵣₚ We may achieve that minimization in the long term by hiring more nannys. (§2.4.3)

In the short term, total number of nannys, average nanny review-times, and various numbers of children are relatively constant. So minimization of total review time Tₜₒₜ is accomplished by dynamically allocating nannys to that tier where they are most needed. At any particular moment, it turns out that nanny allocation can be well described as a convex optimization problem [7] where the objective of minimization is total review time. The problem constraints are:
1. total number of nannys NumNannys is assumed constant,
2. number of nannys allocated to any particular tier is, generally, not allowed to exceed the number of children on that tier.
Under the assumptions
NumNannys≦NumKidsₐᵣ+NumKidsₐᵣₚ (4)
and
NumKidsₐᵣₚ≦1 (5)
then this problem is stated mathematically:

$$\begin{matrix}minimize max \{ \frac{{NumKids}_{ar} {T}_{ar}}{{NumNannys}_{ar}} , \frac{{NumKids}_{arp} {T}_{arp}}{{NumNannys}_{arp}} \} \\ subject to 1 \leq {NumNannys}_{ar} \leq {NumKids}_{ar} \\ 1 \leq {NumNannys}_{arp} \leq {NumKids}_{arp} \\ {NumNannys}_{ar} + {NumNannys}_{arp} = NumNannys\end{matrix} \qquad ( 6 )$$

where the variables are NumNannysₐᵣ and NumNannysₐᵣₚ. Otherwise, if NumKidsₐᵣₚ=0, all available nannys are allocated to Tier 2; e NumNannysₐᵣₚ=0

A solution to this convex optimization problem (6) is easily computed quickly since the convex objective of minimization has a unique global minimum for any set of parameters in the constraints assumable under (4) and (5).⁴²The qualifier convex means: when a solution is found, it can be mathematically proved that there exists no better solution.
⁴²Grant & Boyd disclose a method for computing an optimal solution to convex problem (6). [11] Although an optimal solution (nannys allocated) is not necessarily unique, there is provably no better solution. A rounded solution round(NumNannysₐᵣ) and round(NumNannysₐᵣₚ) gives a whole number of nannys allocated to each respective tier.

By this dynamic nanny allocation, optimal performance from the cadre of female nannys is attained. As these momentary constants measuring numbers of children vary, and as measured times for the average nanny to review a child change, convex optimization problem (6) is solved again. It is, in fact, perpetually solved with sufficient frequency so that nannys will be dynamically and optimally allocated to a new tier whenever necessary. At startup for example, NumKidsₐᵣₚ=0; so every nanny will be allocated to Tier 2.

2.4.2 Multiqueue Optimal Nanny Allocation

We now show how convex optimization problem (6) is expressed under a multiqueue system for a large number of children.

With reference to FIG. 8, assume there are only 3 circular queues on Tier 2 for sake of exposition. Define the total number of nannys on Tier 2 at any given moment:
NumNannysₐᵣΔNumNannysₐᵣ₁+NumNannysₐᵣ₂+NumNannysₐᵣ₃ (7)
the total number of kids on Tier 2:
NumKidsₐᵣΔNumKidsₐᵣ₁+NumKidsₐᵣ₂+NumKidsₐᵣ₃ (8)
and time for the average nanny to review a child is: Tₐᵣ₁ seconds on Tier 2 in circular queue 1, Tₐᵣ₂ on Tier 2 in circular queue 2, Tₐᵣ₃ on Tier 2 in circular queue 3, and Tₐᵣₚ on Tier 3. Suppose we want kids in queue 2 to be seen at approximately twice the rate as kids in queue 1, and we want kids in queue 3 to be seen at approximately thrice the rate as kids in queue 1. With variables Tₜₒₜ, NumNannysₐᵣ₁, NumNannysₐᵣ₂, NumNannysₐᵣ₃ and NumNannysₐᵣₚ under the same assumptions (2), (4), and (5), then the convex optimization problem is rewritten

$$\begin{matrix}\begin{matrix}minimize {T}_{tot} \\ subject to 1 \leq {NumNannys}_{ar 1} \leq {NumKids}_{ar 1} \\ 1 \leq {NumNannys}_{ar 2} \leq {NumKids}_{ar 2} \\ 1 \leq {NumNannys}_{ar 3} \leq {NumKids}_{ar 3} \\ 1 \leq {NumNannys}_{arp} \leq {NumKids}_{arp} \\ \begin{matrix}{NumNannys}_{ar 1} + {NumNannys}_{ar 2} + \\ {NumNannys}_{ar 3} + {NumNannys}_{arp} = \\ NumNannys\end{matrix} \\ \frac{{NumKids}_{ar 1} {T}_{ar 1}}{{NumNannys}_{ar 1}} \leq {T}_{tot} \\ \frac{{NumKids}_{ar 2} {T}_{ar 2}}{{NumNannys}_{ar 2}} \leq \frac{{T}_{tot}}{2} \\ \frac{{NumKids}_{ar 3} {T}_{ar 3}}{{NumNannys}_{ar 3}} \leq \frac{{T}_{tot}}{3} \\ \frac{ {NumKids}_{ arp} {T}_{ arp}}{ {NumNannys}_{ arp}} \leq {T}_{ tot} \\ where , upon finding an optimal solution , the \\ total review time is ( confer ( 3 ) )\end{matrix} & ( 9 ) \\ \begin{matrix}{T}_{tot} = max \{ \frac{{NumKids}_{ar 1} {T}_{ar 1}}{{NumNannys}_{ar 1}} , 2 \frac{{NumKids}_{ar 2} {T}_{ar 2}}{{NumNannys}_{ar 2}} , \\ 3 \frac{{NumKids}_{ar 3} {T}_{ar 3}}{{NumNannys}_{ar 3}} , \frac{ {NumKids}_{ arp} {T}_{ arp}}{ {NumNannys}_{ arp}} \}\end{matrix} & ( 10 )\end{matrix}$$

If NumKidsₐᵣₚ=0, then NumNannysₐᵣₚ is set to 0 and that nanny is reallocated to Tier 2. If NumKidsₐᵣ₃=0, then NumNannysₐᵣ₃ is set to 0 and that nanny is reallocated to a nonempty queue on Tier 2, and so on.
2.4.3 How Many Nannys should we Employ?

Total review time Tₜₒₜ is under our control in so far as we deploy a total number of nannys NumNannys sufficient to keep it at some desired level that is strictly less than 8 hours. If Tₜₒₜ were to exceed 8 hours, then we would have no choice but to hire more nannys in order to reduce it. If Tₜₒₜ were only a few minutes, on the other hand, then it is safe to say we have more nannys than we need. A good operating range for Tₜₒₜ is 1 to 4 hours.

Because the number of subscribed kids using their computers peaks daily and fluctuates from day to day, each 8-hour shift of nannys generally sees a different total number of nannys required, on average, to meet desired total review time. Knowing this by experience, our staff is made more fluid by staggering nannys' hours; a practice that is acceptable to many nannys. In other words, certain hours of the day see more or fewer nannys at work.

As the cost of employing nannys is a large expenditure, one might think it prudent to hire cheaper labor overseas. In this particular endeavor for protecting American children, hiring foreign labor is not a good idea for simple reason: Someone who is not raised in the United States, and who does not speak English as their first language, does not comprehend meanings of thousands of common American idioms; e.g., off the top of my head, a piece of my mind, on the ball, can't hold a candle to, close but no cigar, let bygones be bygones, green thumb, dead ringer. Conversely, bloody is an English expletive but not in the US.

2.5 Embodiments Suiting Other Applications

Communication by voice (with anyone who has a conventional telephone or cell phone in the US and some foreign countries) has no monetary cost when a child avails one of the free voice-over-Internet (VOIP) providers like Skype from their computer. Because video (webcam) and audio transmissions now commonly occur over the Internet, the process we developed for protecting children has human nannys both watching and listening to subscribed computers via remote desktop.

But this process is more widely applicable than sexual predation. These same techniques and remote-desktop software we developed can also be applied, for example, to watch for contemplated suicide in teens, to detect premeditated school violence, and to look out for dangerous drug use.

2.5.1 Watching Predators

Precisely the same invention can be used to watch sexual predators themselves. The US government has just passed a Bill requiring convicted sex offenders to wear a GPS (global positioning system) tracking device. The government could also, for example, mandate that all convicted sex offenders have their computers watched by a remote nanny service as disclosed herein. In this manner, we can watch all computer activities of sexual predators; including activities at high risk for sexual predation.

2.5.2 Cell Phones

In the coming years, any present distinction between a cell phone and a handheld or laptop computer will diminish. All cell phones will routinely connect to the Internet just as computers now do; meaning, voice, text, data, and video transmission over the Internet will become a more prominent medium for communication than radio waves or telephone wire. In that case, our process for protecting children will be directly applicable, with little modification, to watching children's cell phones or other remote communication devices.

2.5.3 Artificial Intelligence

Another embodiment of the present invention replaces human nannys with artificial intelligence. Essentially, this means replacing the decision-making capability and education of a human with that of a machine. Advances in artificial intelligence may allow this replacement in about twenty years, but the principles of mathematical optimization disclosed herein will still govern in the circumstance of substantial subscriber load.

### REFERENCES

[1] Testimony of Ernie Allen, President & CEO of the National Center for Missing E Exploited Children, for the United States House of Representatives Committee on the Judiciary Subcommittee on Crime, Terrorism and Homeland Security, June 2005. http://judiciary.house.gov/media/pAfs/allen060905.pdf
[2] Testimony of Parry Aftab, Esq., before the U.S. House of Representatives, Committee on Commerce, Subcommittee on Oversight and Investigations, April 2006. republicans.energycommerce.house.gov/108/Hearings/04042006hearing1820/Aftab.pdf
[3] Ilene R. Berson. Grooming cybervictims: The psychosocial effects of online exploitation for youth. Journal of School Violence, 2(1):5-18, 2003. http://www.cs.auckland.ac.nz/˜john/NetSafe/I.Berson.pdf
[4] Ilene R. Berson, Michael J. Berson, and John M. Ferron. Emerging risks of violence in the digital age: Lessons for educators from an online study of adolescent girls in the United States. Journal of School Violence, 1(2):51-72, 2002. www2.ncsi.edu/unity/lockers/project/meridian/sum2002/cyberviolence/cyberviolence pdf
[5] Hoi Yeung Chan, Thomas Yu-Kiu Kwok, and Fred Tze-Keung Tong. U.S. Pat. No. 6,397,256: Monitoring system for computers and internet browsers, May 28, 2002.
[6] Scott C. Cottrille and Ashesh P. Bakshi. U.S. Pat. No. 6,076,100: Server-side chat monitor, Jun. 13, 2000.
[7] Jon Dattorro. Convex Optimization & Euclidean Distance Geometry. Meboo, 2005.
[8] David A. Fertell of Chester Springs, Pa. (US), and Joseph I. Field Jr. of Herndon, Va. (US). U.S. Pat. No. 6,978,304B2: Method Of Remotely Monitoring An Internet Session, Dec. 20, 2005. Assigned to Pearl Software Inc., Exton, Pa. (US).
[9] Michael D. Ellestad and Robert A. Hayes. U.S. Pat. No. 6,658,466: Method and apparatus for integrating remote human interactive assistance function into software systems, Dec. 2, 2003.
[10] Daniel A. Ford, Reiner Kraft, and Gaurav Tewari. U.S. Pat. No. 6,606,644: System and technique for dynamic information gathering and targeted advertising in a web based model using a live information selection and analysis tool, Aug. 12, 2003.
[11] Michael Grant, Stephen Boyd, and Yinyu Ye. cvx: MATLAB software for disciplined convex programming, 2006. http://www.stanford.edu/˜boyd/cvx
[12] David Bradley Rust. U.S. Pat. No. 6,535,909: System and method for record and playback of collaborative Web browsing session, Mar. 18, 2003.

### 3 SUMMARY

A process is disclosed for protecting children from online predators by installing remote-desktop software on a child's computer, and providing a human female nanny who remotely watches that child's computer desktop. A parent is notified of any threat to the child, or if the child is suspected of defeating the remote-desktop software.

### 4 DRAWINGS

### Brief Description

4.1 Supporting Objects/Advantages/Ramifications

FIG. 1. Nanny watches computer screen of child in contact with predator.

FIG. 2. Venn diagram: Axiomatic assumption of our process.

FIG. 3. Connectivity versus time over one particular week. The lower half of this figure is simply a sum of the hourly graph above; the dotted vertical line illustrates an example summation.

FIG. 4. Fundamental digital signal processing of remote-desktop software.

FIG. 5. Multitasking—Watching four remote kids by using four screens.

FIG. 6. Nanny Graphical User Interface (Nanny GUI).

FIG. 7. Simplified queuing system of a sequential embodiment.

FIG. 8. Optimally watching a large number of kids in sequence.

4.2 Supporting Claims

FIG. 9 illustrates a child on the Internet, watched by a nanny, communicating with a predator.

FIG. 10 replaces unidirectional direct channel from child to nanny FIG. 9) with unidirectional Internet channel via server.

FIG. 11 replaces unidirectional direct channel from child to nanny FIG. 9) with bidirectional direct channel.

FIG. 12 replaces bidirectional direct channel (in FIG. 11) with bidirectional Internet channel via server.

4.2.1 Reference Numerals

200 predator
202 predator's Internet communication channel
204 child's Internet communication channel
206 child
208 child's remote device
210 nanny's unidirectional channel from child's remote device
212 nanny's computer
214 nanny
216 guardian
218 server plus unidirectional ingoing and outgoing channel
220 nanny's bidirectional channel to child's remote device
222 server plus bidirectional channels to nanny and child

### 5 DETAILED DESCRIPTION

5.1 Preferred Embodiment—FIG. 9

A Predator 200 can be located anywhere in the world. In the embodiment illustrated in FIG. 9, the predator communicates over the Internet via some bidirectional channel 202 by using some unspecified communication device. The specific type of communication device used by the predator is irrelevant to the present invention but, for sake of discussion, the predator's communication device could be a computer or cell phone.

A predator's channel 202 for communication is typically any of the pre-existing channels commercially available to the general public such as wireless, DSL, cable, fiber optic, etcetera. The exact type of channel used by the predator is also irrelevant to the present invention.

In the embodiment illustrated, a predator 200 is communicating with a child 206 who typically communicates over the Internet by using a computer or cell phone 208; we refer to each of these as a remote device 208 but the child is not limited to use of only those devices. Like the predator, the child also uses some commercial pre-existing bidirectional channel 204 for connection to the Internet. Computer programs facilitating communication are plentiful, carry no monetary cost, and are often pre-installed on the child's remote device or easily acquired and operated via webpages commonly found on the Internet.

Unbeknownst to a predator 200, this particular child illustrated 206 is being protected by a human nanny 214 whose job is to watch for threats to the child. These threats come in the form of communications to and from the child, made via the Internet, that appear on the desktop (§2.1.2.1, visual screen image) of the child's remote device 208. The nanny uses a computer 212 to watch the child's desktop; e any audio/visual communication transmitted to or from a child's remote device 208 over the Internet is available to the nanny on her computer 212. Remote-desktop software installed on the child's remote device 208 transmits replicas of the child's desktop to the nanny.

A nanny 214 need not be in physical proximity to a child 206 she watches; indeed, the nanny can be in the same room as the child or she can be located many miles away. There exists a unidirectional channel 210 for transmission of the child's desktop (plus audio) to the nanny. This pre-existing channel is unidirectional because a nanny need not communicate with a child, nor must a nanny have control of a child's remote device 208. This unidirectional child-to-nanny channel 210 is not necessarily the Internet; the connection may be direct, for example, an intranet or local area network.

For the particular threat posed by an online predator 200, a guardian 216 is often a parent.
GUARDIAN: One entrusted with the care of another person.
   But a guardian could also be an officer of law enforcement. The roles of child 206 and predator 200 can be reversed if instead the predator were being watched by a nanny 214. In that case, an officer acting as guardian 216 would be appropriate.
   5.1.1 Operation of Preferred Embodiment—FIG. 9

A predator 200 trawls the Internet hunting children. It is given that the person 206 using remote device 208 is a child. We assume a nanny 214 who is intelligent, raised and educated in the United States, well versed in chatroom lingo, and who has English as her first language if she is watching a child who communicates in English. We assume this nanny is capable of recognizing a threat in the form of sexual solicitation or grooming for a later encounter, plans to meet a stranger (or anyone whom the child has never physically met), premeditated violence at school, contemplated suicide, and talk of dangerous drug use.

Remote-desktop software is installed on a child's remote device 208 by a guardian 216. Remote-desktop software for this purpose is commercially available or it can be custom made; it is provided to the guardian via conventional media for software distribution. Installation requires a password known only to the guardian.

The salient feature of remote-desktop software is transmission via pre-existing channel 210 of each and every distinct screen image, seen by a child 206, to a nanny's computer 212.
SCREEN IMAGE: All the video plus audio perceivable on
   a remote device 208; the Desktop.
      The nanny 214 sees and hears what the child 206 sees and hears.

Transmission from a child's remote device 208 to a nanny's computer 212 occurs whenever the child's remote device is powered on and channel 210 is established. Transmission is expected in accordance with previously collected daily, weekly, or monthly patterns of activity and connectivity for that particular child 206. Because the child is not permitted to uninstall or deactivate the remote-desktop software, statistically significant deviations from past patterns will make the child suspect to tampering, as disclosed in §2.1.2. In other words, a guardian 216 gets a telephone call from a nanny 214 if the child's remote device is not visible to the nanny when it is expected to be, or if the nanny suspects the child of tampering with the remote-desktop software. If the nanny errs in her judgement of suspected tampering, then she errs on the side of caution while preserving the child's safety.

FIG. 9 depicts an embodiment, of our process for protecting children, where a child 206 is in communication with an individual 200 who can be physically located anywhere in the world. This individual communicates over the Internet via channel 202 while the child communicates over the Internet by remote device 208 via channel 204. Nanny 214 can read all written communications, hear all audio, see all video, and view all windows on the child's desktop via channel 210 despite encryption of any transmission to or from the child's remote device over Internet channel 204. The nanny ascertains whether that individual 200 is a predator by content and context of his communications with the child. Or the nanny can identify the individual by his handle (§2.1.6), which is unique to any particular email or chatroom provider, because the nanny has access to a database of known predators and non-predators and because she can google that handle.

If a nanny 214 reasonably suspects that an individual 200 is indeed a predator, or if she detects any other threat to a child 206, then the nanny notifies a guardian 216.

5.2 Additional Embodiment—FIG. 10

The present embodiment in FIG. 10 is identical to that depicted in FIG. 9 with the exception that the unidirectional channel 210 is replaced with 218 a server (§2.1.7) plus a unidirectional channel from the child's remote device 208 to the server plus a unidirectional channel from the server to the nanny's computer 212. Channel 218 in FIG. 10 can (but need not) be the Internet; i.e., the child's remote-desktop software can communicate with a server over the Internet who then relays desktop data to the nanny also by way of Internet.

5.2.1 Operation of Additional Embodiment—FIG. 10

There is no difference in operation of this embodiment of the invention drawn in FIG. 10 with that depicted in FIG. 9 (disclosed in §5.1.1) with the exception of how the child/nanny channel 218 is physically implemented.

5.3 Alternative Embodiment 1—FIG. 11

The child/nanny channels 210 and 218, respectively drawn in FIG. 9 and FIG. 10, are unidirectional because we assure guardians that control of their child's remote device by a nanny is impossible by design of the remote-desktop software installed on it. A bidirectional channel is, therefore, not technically precluded by this assurance to guardians. In other words, an alternative embodiment need not provide that assurance if guardians instead want less involvement in the process of Intervention.

FIG. 11 illustrates a bidirectional channel 220 so a nanny 214 can now control a child's remote device 208 by virtue of design of the remote-desktop software installed on it. Otherwise, the present embodiment in FIG. 11 is identical to FIG. 9 with the exception of the now bidirectional channel 220. The guardian element 216 is, therefore, no longer elemental.

5.3.1 Operation of Alternative Embodiment 1—FIG. 11

Operation of the present embodiment in FIG. 11 is identical to that in FIG. 9, as disclosed in §5.1.I, with the exception that a nanny's first action is not necessarily to alert a guardian when a threat or suspected predator 200 is detected. Instead, the nanny 214 executes countermeasures after taking control of a child's remote device 208 via bidirectional channel 220.

A nanny may then proceed with legalized entrapment techniques (§1.1.2), for example, as an alternative to Intervention. Another effective countermeasure is to block any communication with a suspected predator 200; his chatroom handle or email address. If the predator is known, then our remote-desktop software can block communication with him on a child's remote device 208 automatically. Another countermeasure is to block all chatroom communications on a child's remote device. A less radical countermeasure has a nanny 214 communicate directly with the child 206; the nanny asks the child to stop communicating with a suspected predator, or to stop a particular behavior.

There are many effective countermeasures, too numerous to mention here, that can be implemented by controlling a child's remote device. These preceding few examples should not be construed as limiting the number or kind of countermeasures possible; rather, they should serve as representatives of all that is possible when a child's remote device can be remotely controlled.

5.4 Alternative Embodiment 2—FIG. 12

Another alternative embodiment can be derived from FIG. 10 by making the unidirectional channel 218 instead bidirectional 222; i.e., the present embodiment drawn in FIG. 12 is identical to FIG. 10 with the exceptions of now bidirectional channel 222 and a missing guardian 216. The guardian is no longer necessary to this embodiment's operation because a nanny 214 does not rely on the guardian to Intervene. Channel 222 in FIG. 12 can (but need not) be the Internet.

5.4.1 Operation of Alternative Embodiment 2—FIG. 12

This embodiment of the invention drawn in FIG. 12 operates identically to the embodiment in FIG. 11, as disclosed in §5.3.1, with the exception of how the child/nanny channel 222 is physically implemented.

### 6 CONCLUSION

We have disclosed, herein, a process for protecting children from threats they may encounter on the Internet. The principal advantage of the present invention over prior art is the human element. Conventional technological approaches that rely almost exclusively on software, like surveillance spyware installed on a child's computer (or handheld device), can be easily fooled because state-of-the-art artificial intelligence has not yet achieved IQ of the average child on the Internet. By adding human nannys to the equation, our process for protecting children is not so easily fooled. We expect this to remain the case for at least the next twenty years.

The greatest obstacle to protecting children is the children themselves; they find ways to defeat conventional surveillance spyware installed on their computers by their parents. The specific advantage of our remote-desktop approach is that a parent will get a telephone call from a nanny if their child has tampered with the remote-desktop software installed on their computer; what previously has gone undetected by the parent we now make apparent by characterizing a child's activity and connectivity, as disclosed in §2.1.2.

The remote-desktop approach we developed does not constitute spying because the remote-desktop software itself makes children well aware of a nanny's presence on their computers. Children behave better, in fact, when they know they are being watched.

The computer communication industry (chatroom and email providers) is now heading in the direction of encrypting chat for purposes of privacy and security. This means it is becoming impossible for contemporary surveillance spyware to monitor Internet transmissions to and from a child's computer. The great advantage of our remote-desktop approach is that it is immune to encryption. In other words, the nanny sees whatever the child sees on their computer screen. This aspect of the invention renders encryption moot.

What has prohibited the present invention from being realized sooner was
its economic feasibility, and
threat of liability lawsuits arising from allegations of negligence by nannys who are responsible for many children's safety.

We have proven economic feasibility of this process for protecting many children by applying the mathematics of convex optimization in §2.4 where we described a tiered system of nannys operating in concert. Nanny performance is individually measured in real time and then tiering is optimized by allocating nannys to minimize total time for review of all children. Another element that we introduced to induce economic feasibility is the concept time compression which we disclose as a method for compressing review of a child's past 8-hour record to only a few minutes on average. (§2.1.4-§2.1.8)

To avoid complaints of liability, we introduced much redundancy into the tiered nanny system; i.e., each child is seen by many nannys during their perpetual course of observation. Probability that an event critical to a child's safety would be missed is thereby minimized by the many eyes on that child.

These considerations of economic feasibility, liability, and other obstacles to success of this invention, that we have overcome in practice, all contribute ramifications to its embodiment. Some ramifications are disclosed in detail in Background §2. But one element of the invention remains constant throughout:
Human nannys remotely watch computer screens of children.
   This essence is fundamental to the claims.

Although the description above contains many specificities, they should not be construed as limiting scope of the invention; they should instead be construed merely as providing illustrations of some presently preferred embodiments.

We have disclosed usefulness of this invention for protecting children from online predators, premeditated violence at school, and contemplated suicide. But because a nanny is assumed to be intelligent and educated, she is not limited to discerning only those threats.

For example, a nanny may screen children for dangerous drug use or any threat presently unforeseen.

For a second example, the present invention can be adapted without modification to watching the predators themselves. The role of nanny would then revert to a police officer whose duty is to watch felons convicted of child molestation; much like felons are now required to wear GPS devices on their ankles, or to register their email addresses and chatroom handles with police.

For a third example, while the drawings (FIG. 9-FIG. 12) only illustrate one child in the process, it is understood that this same process is adapted to watch many children as disclosed in Background §2. Similarly, the same process is adapted to incorporate many nannys.

Thus the scope of this invention should be determined by the appended claims and their legal equivalents rather than by the examples given.

I claim:

1. A process for protecting at least one child from at least one predetermined online threat comprising:
a. providing remote-desktop software on at least one remote device,
b. providing at least one human watching the desktop of said remote device having predetermined activity,
whereby a guardian is notified if said remote-desktop software is suspect to defeat, and whereby obfuscation, due to an encrypted transmission to and from said remote device, is circumvented.

2. The process for protecting children of claim 1 wherein said remote-desktop software displays a notification, on said desktop, selected from the group consisting of:
a. an icon, and
b. a balloon, and
c. a webpage, and
d. other predetermined informative window,
whereby said children are made aware of protection by said human.

3. The process for protecting children of claim 1 wherein said human watches and hears said remote device via computer.

4. The process for protecting children of claim 1 wherein a plurality of humans redundantly watch said remote device.

5. The process for protecting children of claim 1 further alerting said guardian of said online threat on said remote device, whereby said guardian can commence discretionary countermeasures.

6. The process for protecting children of claim 5 wherein said guardian is alerted by said human.

7. The process for protecting children of claim 5 further providing a second opinion prior to alerting said guardian.

8. The process for protecting children of claim 1 further prohibiting said human from controlling said remote device, whereby said guardian is satisfied.

9. The process for protecting children of claim 8 wherein said human is prohibited, from controlling said remote device, by an element selected from the group consisting of:
a. said remote-desktop software, and
b. a server, and
c. a nanny graphical user interface, and
d. other predetermined element.

10. The process for protecting children of claim 1 further controlling said remote device upon detection of said online threat thereon, whereby said remote-desktop software, a server, and said human can initiate predetermined countermeasures independently and in concert.

11. The process for protecting children of claim 1 further providing time compression, whereby said human can watch and hear said remote device more quickly than real time.

12. The process for protecting children of claim 1 further providing an optimization algorithm, whereby the plurality of humans are optimally allocated so that said children are reviewed in a least amount of time.

13. The process for protecting children of claim 1 further sorting the plurality of children by a criterion selected from the group consisting of:
a. threat level, and
b. risk level, and
c. age, and
d. sex, and
e. other predetermined criterion,
whereby said children are prioritized and each individual child's behavior is characterized.

14. The process for protecting children of claim 1 wherein said human is exclusively female, whereby said guardian is satisfied.

15. The process for protecting children of claim 1 wherein a predator and said child are interchanged, whereby the remote device of said predator can instead be watched and heard.

16. The process for protecting children of claim 1 wherein said remote device is selected from the group consisting of:
a. computer, and
b. laptop computer, and
c. cell phone, and
d. personal digital assistant, and
e. handheld computerized device, and
f. worn computerized device, and
g. other predetermined device.

17. The process for protecting children of claim 1 wherein said remote-desktop software is suspendable and uninstallable only via password and schedule specified by said guardian.

18. The process for protecting children of claim 1 wherein said predetermined activity is detected by an element selected from the group consisting of:
a. said remote-desktop software, and
b. a server, and
c. said human, and
d. other predetermined element,
whereby only the remote devices of active children at risk are watched and heard.

19. The process for protecting children of claim 1 wherein said human watches a plurality of remote devices.
